(19) United States
(12) Patent Application Publication
(10) Pub. No.: US 2013/0162064 A1
(43) Pub. Date: Jun. 27, 2013

(54) LAMINATED CORE AND METHOD FOR MANUFACTURING THE SAME

(71) Applicants: Changsung Sean Kim, Gyunggi-do (KR); Guen Hong Lee, Seoul (KR); Han Kyung Bae, Gyunggi-do (KR); Chang Hwan Choi, Gyeonggi-do (KR); Ji Hye Shim, Gyunggi-do (KR)

(72) Inventors: Changsung Sean Kim, Gyunggi-do (KR); Guen Hong Lee, Seoul (KR); Han Kyung Bae, Gyunggi-do (KR); Chang Hwan Choi, Gyeonggi-do (KR); Ji Hye Shim, Gyunggi-do (KR)

(73) Assignee: SAMSUNG ELECTRO-MECHANICS CO., LTD., Gyunggi-do (KR)

(21) Appl. No.: 13/408,979

(22) Filed: Feb. 29, 2012

(30) Foreign Application Priority Data
Dec. 22, 2011 (KR) 1020110140351

(51) Int. Cl. H02K 1/02; B05D 5/12; H02K 15/10

(52) U.S. Cl. 310/44; 427/128

(57) ABSTRACT

Disclosed herein is a laminated core used for a motor such as an electric motor, including: a unit laminate laminated in at least one layer and formed of a soft magnetic composite, wherein each powder particle forming the soft magnetic composite is insulation-coated. The preferred embodiments of the present invention can improve the mechanical strength of the core of the soft magnetic composite by manufacturing the core using the laminating method of the soft magnetic composite and reduce core loss by performing insulation coating on powder particles forming the soft magnetic composite.

### CROSS REFERENCE TO RELATED APPLICATION

This application claims the benefit of Korean Patent Application No. 10-2011-0140351, filed on Dec. 22, 2011, entitled “Laminated Core and Manufacturing Method thereof”, which is hereby incorporated by reference in its entirety into this application.

### BACKGROUND OF THE INVENTION

1. Technical Field

The present invention relates to a laminated core and a method for manufacturing the same.

2. Description of the Related Art

Generally, a motor such as a power plant, an electric motor, or the like, is formed in a structure in which windings are inserted into a rotor core and a stator core in an outer box.

In this configuration, the rotor core and the stator core are formed by forming cores by punching a thin silicon steel and then, laminating the cores. At the time of laminating each core, the cores are configured to have a gap formed therebetween at a predetermined distance.

However, when laminating the silicon steel, an eddy current loss may be increased, efficiency may be degraded, consumption of copper may be increased.

In order to solve the above problems, a method of using magnetic powder materials has been proposed for manufacturing the cores. Japanese Patent Laid-Open Publication No. 1994-245456 discloses a method for improving efficiency while reduce magnetic resistance of a magnetic pass between cores by forming the cores in a molded article of soft magnetic metallic powders.

However, when integrally forming the cores like the molded article of the magnetic powder materials, a serious problem of degrading mechanical strength occurs. In addition, when using a soft magnetic composite in an original state, a core loss may occur due to electrical property between powder particles forming the soft magnetic composite.

### SUMMARY OF THE INVENTION

The present invention has been made in an effort to provide a laminated core and a method for manufacturing the same capable of reducing a core loss by performing insulating coating on powder particles forming a soft magnetic composite while increasing strength and efficiency of cores, by manufacturing the cores using a method for laminating a soft magnetic composite in forming the cores of the soft magnetic composite.

According to a preferred embodiment of the present invention, there is provided a laminated core used for a motor such as an electric motor, including: a unit laminate laminated in at least one layer and formed of a soft magnetic composite, wherein each powder particle forming the soft magnetic composite is insulation-coated.

The unit laminate may be formed to have a thickness of 0.1 mm or less in a laminated direction.

According to a first preferred embodiment of the present invention, there is provided a method for manufacturing a laminated core, including: forming a unit laminate on a support by applying a coating solution including a soft magnetic composite formed of insulation-coated powder particles to the support by a spin coating method; and laminating the unit laminate in plural in a thickness direction.

The unit laminate may be formed to have a thickness of 0.1 mm or less in a laminated direction.

According to a second preferred embodiment of the present invention, there is provided a method for manufacturing a laminated core, including: forming a unit laminate on a targeted substrate by applying a coating solution including a soft magnetic composite formed of insulation-coated powder particles to the targeted substrate by a screen printing method; and laminating the unit laminate in plural in a thickness direction.

The unit laminate may be formed to have a thickness of 0.1 mm or less in a laminated direction.

According to a third preferred embodiment of the present invention, there is provided a method for manufacturing a laminated core, including: forming a unit laminate on a front substrate by applying a coating solution including a soft magnetic composite formed of insulation-coated powder particles to the front substrate by a slot die coating method; and laminating the unit laminate in plural in a thickness direction.

The unit laminate may be formed to have a thickness of 0.1 mm or less in a laminated direction.

According to a fourth preferred embodiment of the present invention, there is provided a method for manufacturing laminated core, including: forming a unit laminate on a base substrate by applying a coating solution including a soft magnetic composite formed of insulation-coated powder particles to the base substrate by a gravure roll printing method; and laminating the unit laminate in plural in a thickness direction.

The unit laminate may be formed to have a thickness of 0.1 mm or less in a laminated direction.

### BRIEF DESCRIPTION OF THE DRAWINGS

FIG. 1A is a diagram showing a stator core to which a laminated core according to a preferred embodiment of the present invention is applied;

FIG. 1B is a partially enlarged cross-sectional view of a unit laminate according to a preferred embodiment of the present invention;

FIG. 2 is a schematic diagram of a method for forming a laminated core according to a first preferred embodiment of the present invention;

FIG. 3 is a schematic diagram of a method for forming a laminated core according to a second preferred embodiment of the present invention;

FIG. 4 is a schematic diagram of a method for forming a laminated core according to a third preferred embodiment of the present invention; and

FIG. 5 is a diagram showing a method using gravure roll printing for forming a laminated core according to a fourth embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the present invention may be modified in various different ways and is not limited to the embodiments provided in the present description. In addition, the terms “first”, “second”, “one surface”, “the other surface” and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

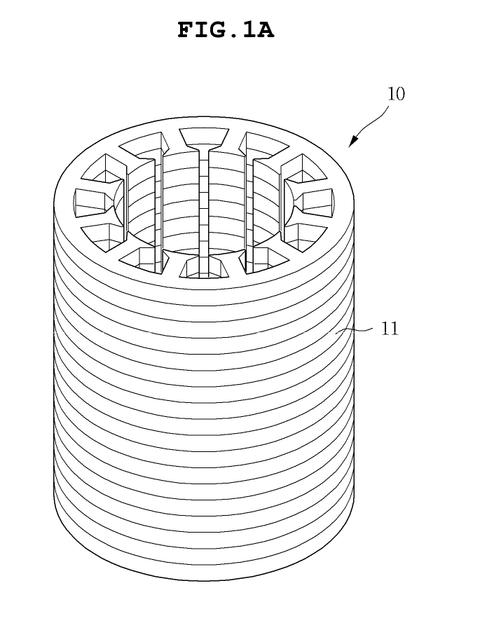

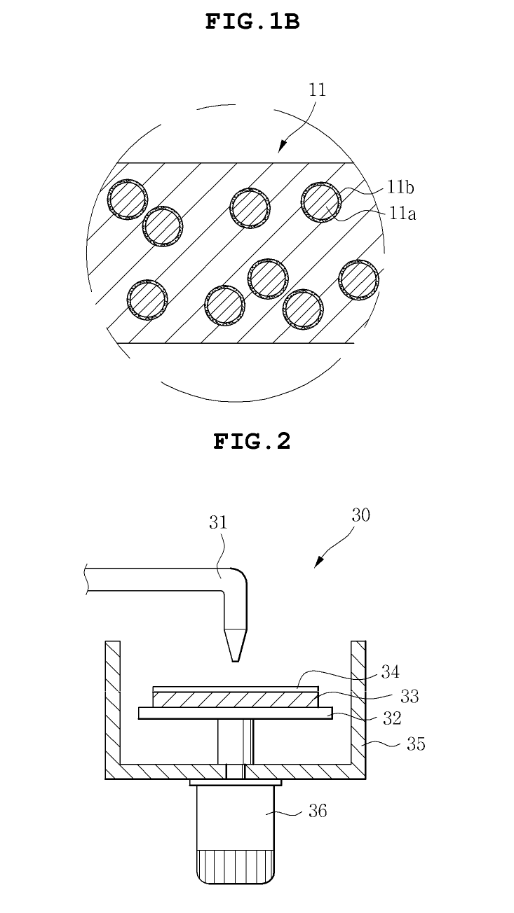

FIG. 1A is a diagram showing a stator core to which a laminated core according to a preferred embodiment of the present invention is applied and FIG. 1B is a partially enlarged cross-sectional view of a unit laminate according to a preferred embodiment of the present invention.

The laminated core according to the preferred embodiment of the present invention is a core used for a motor such as an electric motor, or the like. The core includes a unit laminate 11 formed of a soft magnetic composite and laminated in at least one layer and each powder particle 11a forming the soft magnetic composite is insulation-coated 11b.

The laminated core according to the preferred embodiment of the present invention is a core used for a motor such as an electric motor, or the like. The core is formed of magnetic powder materials and has a structure in which at least one unit laminate 11 is laminated.

The magnetic powder material used for the laminated core according to the preferred embodiment of the present invention, that is, the soft magnetic composite including the powder particles 11a is used as a usage like core materials of inductors, stators, rotors, an actuator, a sensor, and a transformer core for electrical devices. Generally, the soft magnetic core such as the rotors, the stators, or the like, in the electrical devices is formed of stacked steel laminates. The soft magnetic composite (SMC) material is based on soft magnetic particles. Generally, the soft magnetic composite material is based on iron particles in which each particle is covered with electrical insulation coating. Soft magnetic composite parts are manufactured by selectively compressing the insulated particles using a powder metal process, together with a lubricant or a binder. The soft magnetic composite material may accommodate a three-dimensional magnetic flux by using a powder metal technology and a three-dimensional shape may be obtained by a compression process, such that the SMC parts having the higher freedom of design at the time of manufacturing the soft magnetic composite parts can be produced.

Further, the soft magnetic powder (or metal powder) particles 11a may be coated with insulating materials and the powder particles 11a may have various shapes such as a three-dimensional shape (for example, a polyhedral shape such as a rectangular parallelepiped shape, or the like, an oval shape such as a spherical shape, a cylindrical shape, a donut shape, or the like) and a two-dimensional thin film shape (for example, a thin slice chip shape, a flake shape, or the like). Meanwhile, polyamide-based resin serving as a binder is filled between the soft magnetic powder particles 11a to maintain the structural strength and shape.

In particular, in the case of non-crystalline soft magnetic powder particles 11a, the powder particles 11a having any three-dimensional shape or a two-dimension thin film shape is insulation-coated and the polyamide-based resin, or the like, serving as the binder is filled between the soft magnetic powder particles 11a, thereby maintaining the structural strength and shape.

As described above, the preferred embodiment of the present invention performs the insulation coating 11b on each of the soft magnetic powder particles 11a forming the soft magnetic composite and laminates the unit laminate 11 including the same in plural, thereby improving the rigidity of the laminated core and preventing the core loss occurring between the powder particles.

The core is manufactured by forming the unit laminate 11 using the soft magnetic composite and laminating the formed unit laminate 11 in a thickness direction. The thin unit laminate 11 is laminated in plural by forming a thickness of the unit laminate 11 at 0.1 mm or less, thereby more improving the mechanical strength.

FIG. 1A shows a perspective view of a stator core 10 formed in a laminated structure using the soft magnetic composite according to the preferred embodiment of the present invention. The efficiency of the eddy current loss may be improved by forming the core 10 using the soft magnetic composite and the problem of the mechanical strength may be solved by being formed in the laminated structure. In particular, the thickness of the unit laminate 11 may be formed at 0.1 mm or less in forming the core 10 having the laminated structure. The core 10 is manufactured by laminating the unit laminate 11 at 0.1 mm or less, thereby more improving the mechanical strength and the eddy current loss is prevented by using the soft magnetic composite, thereby improving the efficiency.

As shown in FIG. 1B, the core less occurring between the powder particles 11a may be prevented by performing the insulating coating 11b on each of the soft magnetic powder particles 11a forming the soft magnetic composite.

Further, when the magnetic materials are exposed to a fluctuation magnetic field, the energy loss occurs due to the hysteresis loss and the eddy current loss. The hysteresis loss is in proportion to a frequency of an alternating magnetic field, while the eddy loss is in proportion to a square of a frequency. Therefore, the eddy current loss is generally important. Accordingly, it is preferable to increase resistance so as to maintain the hysteresis loss at a low level while reducing the eddy current loss. In order to improve the resistance, the insulation coating 11b or the thin film may be covered on the powder particles 11a.

An example of the soft magnetic composite according to the preferred embodiment of the present invention may include moly-permalloy powder (MPP) (81% Ni-17% Fe-2% Mo) as nickel-based alloy and sendust (85% Fe-9.5%/si-5, 5% Al) as iron alloy. The preferred embodiment of the present invention is not limited thereto and therefore, the soft magnetic composite material of various materials selectable by those skilled in the art may be used.

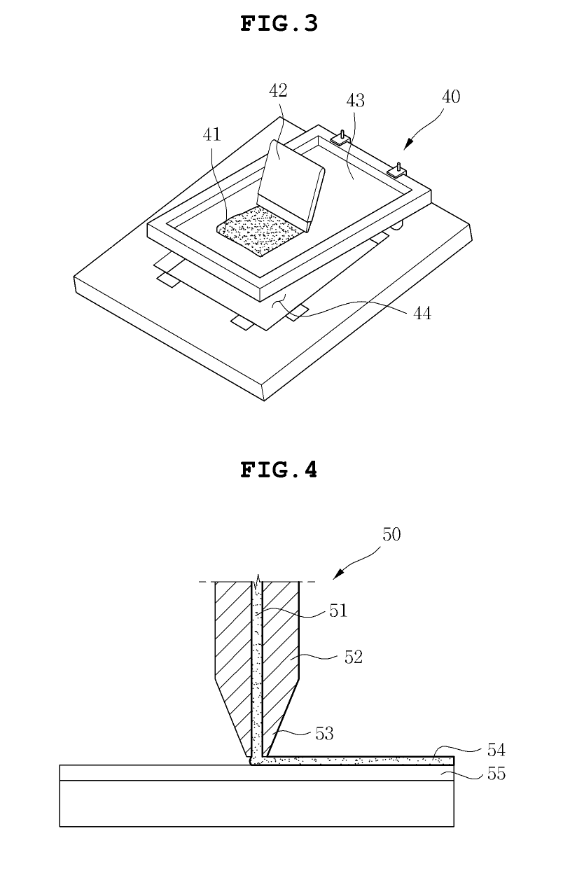

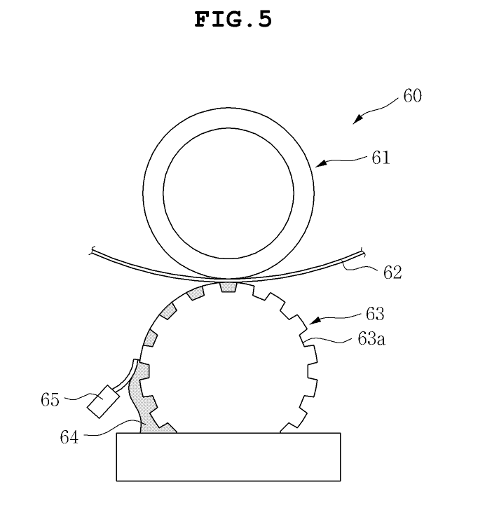

FIGS. 2 to 5 show various preferred embodiments of a method for manufacturing a laminated core according to the preferred embodiment of the present invention. In detail, FIG. 2 is a schematic diagram of a method for forming a laminated core according to a first preferred embodiment of the present invention, FIG. 3 is a schematic diagram of a method for forming a laminated core according to a second preferred embodiment of the present invention, FIG. 4 is a schematic diagram of a method for forming a laminated core according to a third preferred embodiment of the present invention, and FIG. 5 is a diagram showing a method using gravure roll printing for forming a laminated core according to a fourth embodiment of the present invention.

FIG. 2 is a diagram showing a method using spin coating, as a first preferred embodiment of the present invention for forming the laminated core.

A method for manufacturing a laminated core according to the first preferred embodiment of the present invention includes forming a unit laminate 34 on a support 33 by applying a coating solution including the soft magnetic composite formed of the insulation-coated powder particles 11a to the support 33 by the spin coating method and laminating the unit laminate 34 in plural in a thickness direction. In particular, the unit laminate 34 may be formed to have a thickness of 0.1 mm or less in a laminated direction by the spin coating method. Thereby, the laminated core formed of the soft magnetic composite in a laminated shape having the more excellent rigidity may be manufactured. Further, the core loss may be reduced by performing the insulation coating 11b on the powder particles 11a forming the soft magnetic composite.

In detail, the method using the spin coating is performed in a method for manufacturing the unit laminate 34 by applying the coating solution including the soft magnetic composite formed of the insulation-coated powder particles 11a to the support 33 by a spin coating apparatus and laminating the unit laminate 34 in plural.

As shown in FIG. 2, the spin coating apparatus includes a nozzle 31 for providing the coating solution including the soft magnetic composite formed of the insulation-coated 11b powder particles 11a, a chuck 32 attached to a cup 35 to chuck the support 33, and a motor 36 rotating the chuck 32 together with the support 33. In particular, the spin coating method is to make the thickness of the unit laminate 34 uniform. The spin coating method is configured to include homogenizing and drying. At the homogenizing, in order to apply the coating solution including the soft magnetic composite formed of the insulation-coated 11b powder particles 11a, the support 33 is rotated by selecting a setting rotation speed corresponding to the desired thickness of the unit laminate 34, a predetermined rotation time, and a product of the setting rotation speed and the predetermined rotation time. At the drying, the support 33 is rotated at a rotation speed lower than the setting rotation speed during the homogenizing, such that the unit laminate may be formed of the soft magnetic composite formed of the insulation-coated 11b powder particles 11a. The unit laminate 34 manufactured as described above is laminated in plural in the thickness direction and is cut and machined in the core shape, thereby manufacturing the core of the laminated structure.

FIG. 3 is a diagram showing a method using screen printing as a second preferred embodiment of the present invention for forming the laminated core.

The method for manufacturing a laminated core according to the second preferred embodiment of the present invention includes forming the unit laminate on a targeted substrate 44 by applying the coating solution including the soft magnetic composite formed of the insulation-coated 11b powder particles 11a to the targeted substrate 44 by the screen printing method and laminating the unit laminate in plural in the thickness direction. In particular, the unit laminate may be formed so as to have a thickness of 0.1 mm or less in the laminated direction by the screen printing method. As a result, the laminated core formed of the soft magnetic composite in the laminated shape having more excellent rigidity may be manufactured. In addition, the core loss may be reduced by performing the insulating coating 11b on the powder particles 11a formed of the soft magnetic composite.

In detail, the screen printing method may manufacture the unit laminate on the targeted substrate 44 by adhering a coating solution 41 including the soft magnetic composite formed of the powder particles 11a insulation-coated 11b by a screen 43 to the screen 43 by a squeeze 42. In this case, the unit laminate suitable to manufacture the core may be formed by controlling a pattern shape of the screen 43. In addition, the pattern in the core shape may be manufactured by the screen 43. The laminated core may be manufactured by laminating the unit laminate of the soft magnetic composite formed of the insulation-coated 11b powder particles 11a manufactured as described above in plural in the thickness direction.

FIG. 4 is a diagram showing a method using slot die coating as a third preferred embodiment of the present invention for forming the laminated core.

The method for manufacturing a laminated core according to the third preferred embodiment of the present invention includes forming a unit laminate 54 on a front substrate 55 by applying the coating solution including the soft magnetic composite formed of the insulation-coated 11b powder particles 11a to the front substrate 55 by the slot die coating method and laminating the unit laminate 54 in plural in the thickness direction. In particular, the unit laminate 54 may be formed so as to have a thickness of 0.1 mm or less in the laminated direction by the slot die coating method. As a result, the laminated core formed of the soft magnetic composite in the laminated shape having more excellent rigidity may be manufactured. In addition, the core loss may be reduced by performing the insulating coating 11b on the powder particles 11a formed of the soft magnetic composite.

In detail, the slot die coating is a method supplying a liquid-phase fluid (slurry, adhesive, hard coating solution, ceramic, or the like) having fluidity between the upper and lower molding plate by a non-pulsating pump or a piston pump and coating a fluid supplied from a liquid supply pipe at a constant and uniform thickness in a width direction of a fabric, film, glass plate, and sheet progress direction, wherein the upper and lower molding plate is designed and machined in a molding by a rheology called a slot die. As shown in FIG. 4, the coating solution 51 including the soft magnetic composite formed of the insulation-coated 11b powder particles 11a is applied to the front substrate 55 through the nozzle 53 of the slot die 52, thereby forming the unit laminate 54 on the front substrate 55. The core in the laminated structure may be manufactured by laminating the unit laminate 54 formed as described above in plural in the thickness direction. The rigidity of the laminated core can be secured and the core loss of the laminated core can be reduced, by laminating the unit laminate 54 of the soft magnetic composite formed of the insulation-coated 11b powder particles 11a.

FIG. 5 is a diagram showing a method using gravure roll printing as a fourth preferred embodiment of the present invention for forming the laminated core.

The method for manufacturing a laminated core according to the fourth preferred embodiment of the present invention includes forming the unit laminate on a base substrate 62 by applying the coating solution including the soft magnetic composite formed of the insulation-coated 11b powder particles 11a to the base substrate 62 by the gravure roll printing method and laminating the unit laminate in plural in the thickness direction. In particular, the unit laminate may be formed so as to have a thickness of 0.1 mm or less in the laminated direction by the gravure roll printing method. As a result, the laminated core formed of the soft magnetic composite in the laminated shape having more excellent rigidity may be manufactured. In addition, the core loss may be reduced by performing the insulating coating 11b on the powder particles 11a formed of the soft magnetic composite.

As shown in FIG. 5, the soft magnetic laminated core formed of the insulation-coated 11b powder particles 11a in a three-dimensional shape may be manufactured by implementing pattern parts 63a on a surface of a copper plate roller 63, injecting a coating solution 64 including the soft magnetic composite formed of the insulation-coated 11b powder particles 11a through a lower roller 53 by using a blade 65 to laminate the unit laminate on a base substrate 62 between an upper roller 61 and the lower roller 63 so as to two-dimensionally implement the unit laminate in a desired pattern and then, laminating the unit laminate using a separate laminator.

The preferred embodiments of the present invention can prevent the eddy current loss by forming the cores of the motor, such as the electric motor, or the like, of the soft magnetic composite, thereby improving the efficiency.

In addition, the preferred embodiments of the present invention can improve the mechanical strength of the cores of the soft magnetic composite by manufacturing the cores using the laminating method of the soft magnetic composite.

In addition, the preferred embodiments of the present invention can increase the freedom of design of the cores by forming the cores of the soft magnetic composite.

In addition, the preferred embodiments of the present invention can reduce the consumption of copper by forming the cores using the soft magnetic composite.

Further, the preferred embodiments of the present invention can reduce the core loss occurring between the powder particles by performing the insulation coating on each of the powder particles forming the soft magnetic composite.

In addition, the preferred embodiments of the present invention can improve the efficiency of the electric motor to which the cores formed of the soft magnetic composite is applied by performing the coating processing on each of the powder particles forming the soft magnetic composite.

In addition, the preferred embodiments of the present invention can improve the reliability and productivity of manufacturing without needing to include the separate insulating layer between the unit laminate by performing the coating processing on each of the powder particles forming the soft magnetic composite.

Although the preferred embodiments of the present invention have been disclosed for illustrative purposes, they are for specifically explaining the present invention and thus a laminated core and a method for manufacturing the same according to the present invention are not limited thereto, but those skilled in the art will appreciate that various modifications, additions and substitutions are possible, without departing from the scope and spirit of the invention as disclosed in the accompanying claims.

In addition, any and all modifications, variations or equivalent arrangements should be considered to be within the scope of the invention, and the detailed scope of the invention will be disclosed by the accompanying claims.

What is claimed is:

1. A laminated core used for a motor, comprising:
a unit laminate laminated in at least one layer and formed of a soft magnetic composite,
wherein each powder particle forming the soft magnetic composite is insulation-coated.

2. The laminated core as set forth in claim 1, wherein the unit laminate is formed to have a thickness of 0.1 mm or less in a laminated direction.

3. A method for manufacturing a laminated core, comprising:
forming a unit laminate on a support by applying a coating solution including a soft magnetic composite formed of insulation-coated powder particles to the support by a spin coating method; and
laminating the unit laminate in plural in a thickness direction.

4. The method as set forth in claim 3, wherein the unit laminate is formed to have a thickness of 0.1 mm or less in a laminated direction.

5. A method for manufacturing a laminated core, comprising:
forming a unit laminate on a targeted substrate by applying a coating solution including a soft magnetic composite formed of insulation-coated powder particles to the targeted substrate by a screen printing method; and
laminating the unit laminate in plural in a thickness direction.

6. The method as set forth in claim 5, wherein the unit laminate is formed to have a thickness of 0.1 mm or less in a laminated direction.

7. A method for manufacturing a laminated core, comprising:
forming a unit laminate on a front substrate by applying a coating solution including a soft magnetic composite formed of insulation-coated powder particles to the front substrate by a slot die coating method; and
laminating the unit laminate in plural in a thickness direction.

8. The method as set forth in claim 7, wherein the unit laminate is formed to have a thickness of 0.1 mm or less in a laminated direction.

9. A method for manufacturing a laminated core, comprising:
forming a unit laminate on a base substrate by applying a coating solution including a soft magnetic composite formed of insulation-coated powder particles to the base substrate by a gravure roll printing method; and
laminating the unit laminate in plural in a thickness direction.

10. The method as set forth in claim 9, wherein the unit laminate is formed to have a thickness of 0.1 mm or less in a laminated direction.
